(19) United States
(12) Patent Application Publication
(10) Pub. No.: US 2026/0222644 A1
(43) Pub. Date: Jul. 30, 2026

(54) METHOD, APPARATUS, DEVICE, AND STORAGE MEDIUM FOR EDITING CONTENT

(71) Applicants: Beijing Zitiao Network Technology Co., Ltd., Beijing (CN); Lemon Inc., Grand Cayman (KY)

(72) Inventors: Ruiqi Xia, Beijing (CN); Weijian Chen, Beijing (CN); Ruoxi Wang, CULVER CITY, CA (US); Shuyang Tang, Beijing (CN)

(21) Appl. No.: 19/458,680

(22) Filed: Jan. 23, 2026

(30) Foreign Application Priority Data
Jan. 24, 2025 (WO) PCT/CN2025/075004

(51) Int. Cl. H04N 21/431; H04N 21/45

(52) U.S. Cl. CPC H04N 21/4318; H04N 21/4532

(57) ABSTRACT

A method, an apparatus, a device and a storage medium for editing content are provided. The method includes: executing, in response to an editing request received in a media editing interface, an editing operation associated with the editing request; ceasing presenting the editing interface without terminating the editing operation in response to receiving a preset operation during execution of the editing operation; presenting a reminding message associated with the editing operation in response to a completion of processing the editing operation; and presenting an editing interface in response to a trigger for the reminding message, the editing interface corresponding to an editing state after completion of the editing operation.

### CROSS REFERENCE

This application claims priority to PCT Application No. PCT/CN2025/075004, filed on January 24, 2025, and entitled “METHOD, APPARATUS, DEVICE, AND STORAGE MEDIUM FOR EDITING CONTENT”, the entirety of which is incorporated herein by reference.

### FIELD

Example embodiments of the disclosure generally relate to the field of computers, and in particular, to a method, an apparatus, a device, and a computer-readable storage medium for editing content.

### BACKGROUND

In recent years, with the development of the Internet, more and more users perform interaction activities in a network platform, for example, publishing or browsing media content or template content in the network platform. When a user publishes the media content or template content in a traditional network platform, editing processing needs to be executed on the media content or template content. However, in the process of editing the media content, the user cannot perform other interaction activities, which affects the user interaction efficiency.

### SUMMARY

In a first aspect of the disclosure, there is provided a method for editing content, including: executing, in response to an editing request received in a media editing interface, an editing operation associated with the editing request; ceasing presenting the editing interface without terminating the editing operation in response to receiving a preset operation during execution of the editing operation; presenting a reminding message associated with the editing operation in response to a completion of the editing operation; and presenting a media editing interface in response to a trigger for the reminding message, the media editing interface corresponding to an editing state after completion of the editing operation.

In a second aspect of the disclosure, an apparatus for editing content is provided. The device includes an executing module configured to execute, in response to an editing request received in a media editing interface, an editing operation associated with an editing request; a ceasing module configured to cease presenting the editing interface without terminating the editing operation in response to receiving a preset operation during execution of the editing operation; a reminder module configured to present a reminder message associated with the editing operation in response to a completion of the editing operation; and a presenting module configured to present the media editing interface in response to triggering of the reminding message, the media editing interface corresponding to an editing state after completion of the editing operation.

In a third aspect of the disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the disclosure, a non-transitory computer-readable storage medium is provided. The computer-readable storage medium has a computer program stored thereon, and the computer program is executable by the processor to implement the method of the first aspect.

It should be understood that the contents described in this content section is not intended to limit the key features or major features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which some embodiments of the disclosure may be implemented in real time;

FIGS. 2A-2J illustrate example interfaces in accordance with some embodiments of the disclosure;

FIG. 3 illustrates a flowchart of an example process for editing content according to some embodiments of the disclosure;

FIG. 4 illustrates a schematic structural block diagram of an example apparatus for editing content according to some embodiments of the disclosure; and

FIG. 5 illustrates a block diagram of an electronic device capable of implementing various embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as being limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

It should be noted that the title of any section / subsection provided herein is not limiting. Various embodiments are described throughout and any type of embodiments may be included in any section / subsection. Furthermore, the embodiments described in any section / subsection may be combined in any manner with any other embodiment described in the same section / subsection and / or different sections / subsections.

In the description of the embodiments of the disclosure, the terms “including” and the like should be understood to mean open-ended inclusion, i.e., “including but not limited to”. The term “based on” should be understood as “based at least in part on”. The terms “an embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the disclosure may relate to data of a user, acquisition and / or use of data, and the like. These aspects all follow the corresponding laws and regulations and related regulations. In the embodiments of the disclosure, all data collection, acquisition, treatment, processing, interaction, use and the like are performed on the premise that the user knows and confirms. Accordingly, when implementing the embodiments of the disclosure, the type, the usage scope, the usage scenario, and the like of the data or information that may be involved should be notified to the user and obtain the authorization from the user in an appropriate manner according to the relevant laws and regulations. The specific notification and / or authorization manner may vary according to actual situations and application scenarios, and the scope of the disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing may be performed only within a specified or agreed range. In the case that the user refuses personal information other than necessary information required by the basic function, the use of the basic function will not be affected.

As briefly mentioned above, with the development of the Internet, more and more users perform interaction activities in a network platform, for example, publishing or browsing media content or template content in the network platform. When a user publishes media content or template content in a traditional network platform, editing processing needs to be executed on the media content or template content. However, in the process of editing the media content, the user cannot perform other interaction activities, which affects the user interaction efficiency.

Embodiments of the disclosure provide a solution for editing content. According to the solution, the editing operation associated with an editing request may be executed in response to an editing request received in a media editing interface; during execution of the editing operation, presenting the editing interface is ceased without terminating the editing operation in response to receiving a preset operation; a reminding message associated with the editing operation is presented in response to completion of the editing operation; and the editing interface is presented in response to a trigger for the reminding message, and the editing interface corresponds to an editing state after completion of the editing operation.

In this way, the embodiments of the disclosure may cease presenting the editing interface without ceasing the editing operation based on the operation of the user during execution of the editing operation. In addition, in the embodiments of the disclosure, after the editing operation is completed, the reminding message associated with the editing operation is presented, so that the editing interface may be jumped to by the user based on the reminding message, so as to view the editing state of the editing operation. As such, the embodiments of the disclosure can enable the user to leave the editing interface for carrying out other activities during the execution of the editing operation, saving the time of the user, satisfying the requirement of the user, and improving the efficiency of editing content by the user.

Various example implementations of this solution are described in detail below in conjunction with the accompanying drawings.

### Example Environment

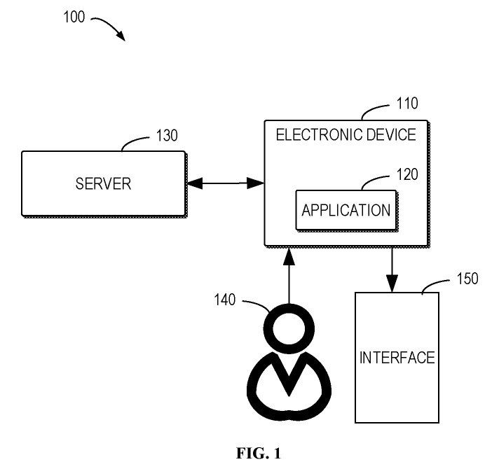

FIG. 1 illustrates a schematic diagram of an example environment 100 in which embodiments of the disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a video editing application, a social application, or other suitable application. The user 140 may interact with the application 120 via the electronic device 110 and / or its attachment device.

In the environment 100 of FIG. 1, if the application 120 is in an activated state, the electronic device 110 may present, through the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR / AR device, a personal communication system (PCS) device, a personal navigation device, a personal digital assistant (PDA), an audio / video player, a digital camera / camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system / server, such as a mainframe, an edge computing node, a computing device in a cloud environment, or the like. The server 130 may provide a background service for an application 120 supporting interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the disclosure are not limited in this regard. In the embodiment of the disclosure, the server 130 and the electronic device 110 may implement signaling interaction through the communication connection between the server 130 and the electronic device 110.

It should be understood that the structures and functions of various elements in the environment 100 are described for illustrative purposes only and do not imply any limitation to the scope of the disclosure.

Some example embodiments of the disclosure will be described below with continued reference to the accompanying drawings.

### Example Interaction

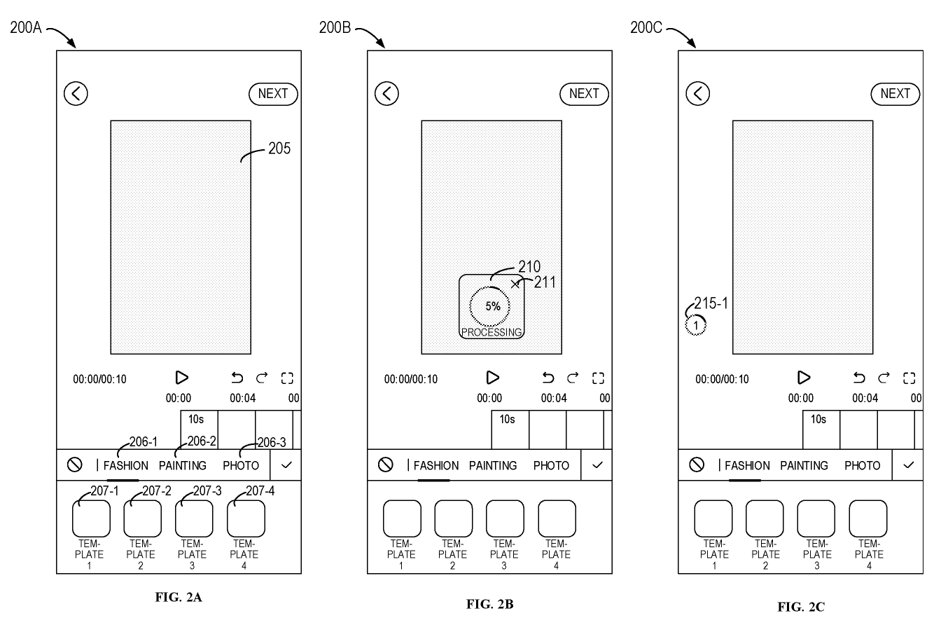

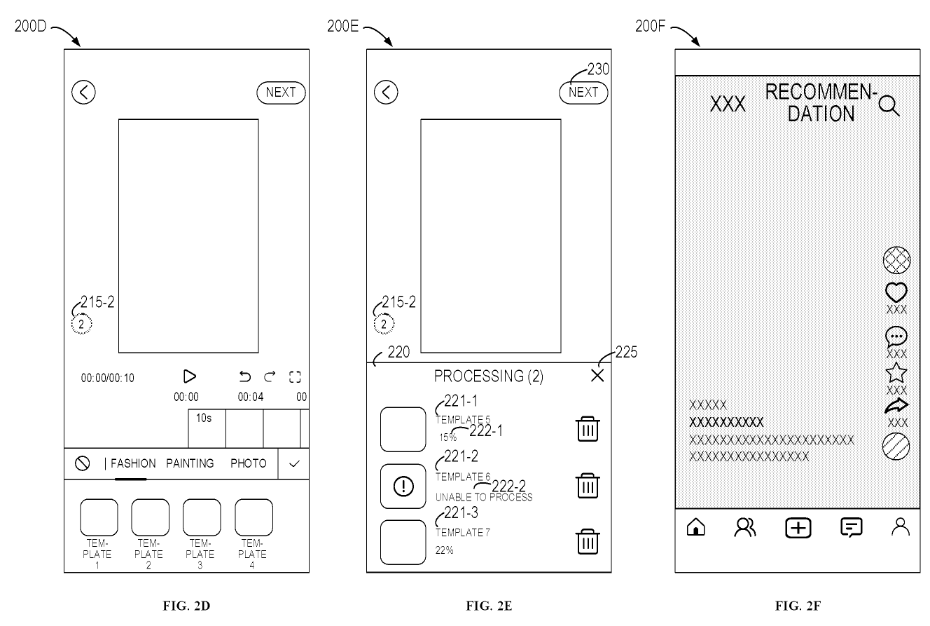

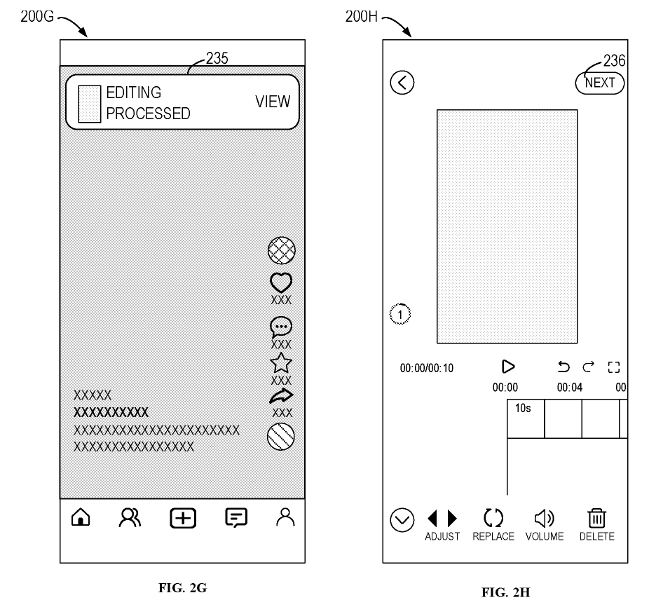

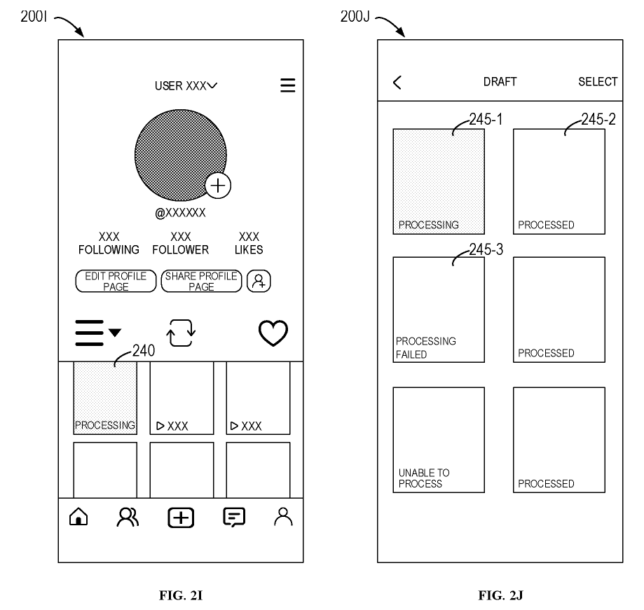

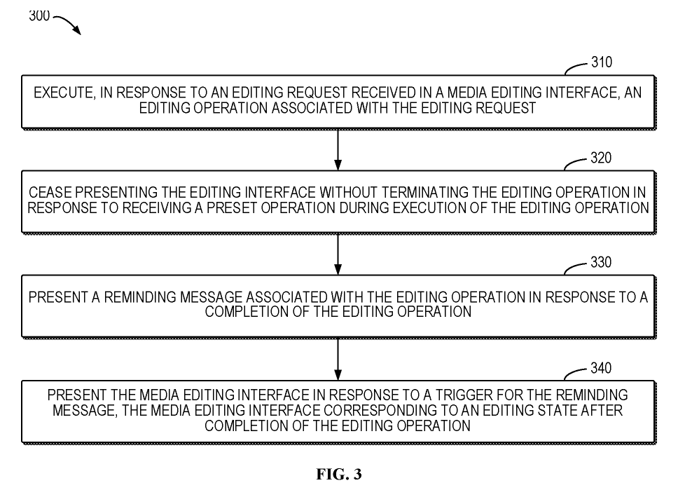

FIGS. 2A-2J illustrate example interfaces 200A-200J according to some embodiments of the disclosure. The interfaces 200A-200J may be provided, for example, by the electronic device 110 shown in FIG. 1.

In some embodiments, as shown in FIG. 2A, the electronic device 110 may present a media editing interface 200A. As an example, the media editing interface 200A may be used to edit content to be edited. As an example, the content to be edited may include, for example, media content and / or template content (or referred to as a media template). For example, the media content for editing may include, for example, video content, audio content, and image-text content. For example, the template content may be used to edit the media content. For example, the template content may include at least one of sticker content, text content, special effects content, filter content, and the like. As an example, the user may edit media content and / or media content based on the media editing interface 200A. Such users may include media content authoring parties and / or template authoring parties.

In some embodiments, the electronic device 110 may present the media editing interface 200A associated with the media template in response to a selection of the media template. As an example, the electronic device 110 may present a viewing interface of information stream. The electronic device 110 may present a media template anchor at the viewing interface. As an example, the media template anchor may be associated with a media template applied to view the media content that is being currently played on the interface. Further, the electronic device 110 may present the media editing interface 200A associated with the media template in response to a trigger (e.g., a click operation) for the media template anchor.

In some occasions, the information stream is also referred to as a Feed stream, which may be associated with multiple works and supports switching to other media content in the playing information stream based on a preset operation (e.g., up-down sliding) of the user on the viewing interface. In some embodiments, the information stream may be associated with a variety of work types. As an example, the work type may include, but is not limited to, a video work, an image-text work, a music work, and the like. The information stream may be a single-row display or a dual-row display, which is not limited in the disclosure.

As an example, the electronic device 110 may present a preview window 205 in the editing interface 200A. The electronic device 110 may present the content to be edited in the preview window 205. Further, the electronic device 110 may update the to-be-edited content presented in the preview window 205 in response to the to-be-edited content being updated.

As an example, the electronic device 110 may execute, in response to the media editing interface 200A receiving an editing request for the content to be edited, an editing operation associated with the editing request to update the content to be edited.

As an example, the editing operation on the editing content may include, for example, clipping, stitching, text adding, special effect adding, and picture adjustment for a video clip or an audio clip.

For example, the electronic device 110 may provide a set of preset editing options in the editing interface 200A. For example, a set of preset editing options includes an option 206-1, an option 206-2, and an option 206-3. Each of the preset editing options may include at least one editing template. For example, the option 206-1 may include an editing template 207-1, an editing template 207-2, an editing template 207-3, and an editing template 207-4, etc. As an example, each editing template may for example correspond to different filter effects, sticker materials, audio effects, or other effects. The electronic device 110 may determine, in response to a selection of the at least one editing template, that the editing request for the content to be edited is received, to perform an editing operation (for example, setting a corresponding filter effect or the like) corresponding to the at least one editing template for the content to be edited. It should be noted that the disclosure is not intended to limit the specific content of the editing operation.

In some embodiments, the electronic device 110 may present, in the editing interface 200A, an indication element associated with the editing operation in response to receiving the editing request.

As an example, as shown in FIG. 2B, the electronic device 110 may present a first indication element 210 associated with the editing operation in an editing interface 200B. As an example, the first indication element 210 may represent a processing progress (e.g., 5%) associated with the editing operation. As an example, the first indication element 210 may also present text content indicating a processing state of the editing operation (e.g., “processing” may represent that the editing operation is in a processing state, and “processed” may represent that the editing operation is in a processing completion state).

Additionally or alternatively, the electronic device 110 may present, in the editing interface 200B, a second indication element associated with the editing operation in response to a preset operation on the first indication element 210 (for example, also referred to as a second preset operation), and cease presenting the first indication element in the editing interface 200B. As an example, the electronic device 110 may present a closing control 211 in the first indication element 210. For example, the preset operation on the first indication element 210 may include, for example, a trigger (for example, a click operation) for the closing control 211.

In some embodiments, as shown in FIG. 2C, the electronic device 110 may present an indication element 215 in an editing interface. As an example, the electronic device 110 may present an indication element 215-1 in an editing interface 200C in response to receiving the editing request. Alternatively, the electronic device 110 may further cease presenting the first indication element 210 in the editing interface 200C in response to a second preset operation on the first indication element 210, and present the indication element 215-1 (for example, also referred to as a second indication element).

As an example, the indication element 215-1 may represent a quantity of editing operations being executed in association with the content to be edited. For example, the electronic device 110 may present a number element in the indication element 215-1 to represent the quantity of editing operations being executed. For example, a number element “1” in the indication element 215-1 may represent that the quantity of editing operations being executed is 1.

As an example, the indication element 215-1 may indicate a total processing progress of the editing operation being executed associated with the content to be edited. For example, the electronic device 110 may present the total processing progress of the editing operation being executed based on an outer boundary of the indication element 215-1. For example, the electronic device 110 may present the outer boundary of the indication element 215-1 with different colors, and a proportion of different colors may represent the total processing progress.

In some embodiments, the editing request mentioned above is a first editing request, and the corresponding editing operation is a first editing operation. The electronic device 110 may trigger parallel execution of the second editing operation associated with the second editing request based on the received second editing request for the content to be edited in response to incompletion of processing the first editing operation. That is, the electronic device 110 may asynchronously process the first editing operation and the second editing operation.

As an example, as shown in FIG. 2D, the electronic device 110 may update the indication element in response to receiving the second editing request for the content to be edited. As an example, the electronic device 110 may present an updated indication element 215-2. For example, the electronic device 110 may present an updated number element (e.g., a number “2”) in the indication element 215-2 to indicate the quantity of editing operations being executed (e.g., 2). As an example, the electronic device 110 may present a color proportion of an updated outer boundary in the indication element 215-2 to represent a total processing progress of two editing operations.

As an example, as shown in FIG. 2E, the electronic device 110 may present a preset panel 220 in an editing interface 200E in response to a preset operation (for example, a click operation) on the indication element (for example, the indication element 215-2). As an example, the electronic device 110 may present a plurality of editing operations in the preset panel 220. For example, the plurality of editing operations may include an operation 221-1, an operation 221-2, an operation 221-3, and the like.

As an example, the electronic device 110 may present processing information for indicating the editing operation in the preset panel 220. The processing information includes at least a processing progress and / or a processing status of the editing operation. For example, electronic device 110 may present text information 222-1 associated with the operation 221-1 to indicate a processing progress (e.g., 15%) associated with the operation 221-1. For example, the electronic device 110 may present text information 222-2 associated with the operation 221-2 to indicate a processing state associated with the operation 221-2 (e.g., being unable to process or processing failed).

As an example, the electronic device 110 may present a deleting control associated with the editing operation in the preset panel 220. For example, the electronic device 110 may present a deleting control 223 associated with the operation 221-1 in the preset panel 220. Further, the electronic device 110 may delete the operation 221-1 to cease processing of the operation 221-1 in response to a trigger (e.g., a click operation) for the deleting control 223.

Additionally or alternatively, the electronic device 110 may present image information associated with the editing operation in the preset panel 220. As an example, electronic device 110 may present text content (e.g., “processing (2)”) in preset panel 220 to represent the quantity of editing operations being executed (e.g., the quantity thereof is 2).

As an example, the electronic device 110 may cease presenting the preset panel 220 in an editing interface 200E in response to receiving a preset operation (for example, a click operation on a control 225) in the preset panel 220.

As an example, the electronic device 110 may publish the content to be edited in response to a received publishing operation during the execution of the editing operation.

Alternatively, the electronic device 110 may present a plurality of options in response to a trigger for a control 230. Alternatively, the plurality of options includes, for example, an option 1 (e.g., “publish content”). Further, the electronic device 110 may publish the content to be edited in response to a trigger for the option 1. As an example, the electronic device 110 may publish content (e.g., media content or a template) determined by processing the content to be edited based on the current processing progress of the plurality of editing operations.

In some embodiments, the electronic device 110 may cease presenting the editing interface without ceasing the editing operation in response to receiving a preset operation during execution of the editing operation.

As an example, the electronic device 110 may cease presenting the editing interface without ceasing the editing operation in response to a type of the editing operation satisfying a preset condition. As an example, the type of the editing operation satisfying the preset condition may include a first type supporting the background running of the editing operation. As an example, the electronic device 110 may cease presenting the editing interface while ceasing the editing operation in response to the type of the editing operation being a second type that does not support the background running of the editing operation.

In some embodiments, the electronic device 110 may present the control 230 in the editing interface 200E. The preset operation that may be received by the electronic device 110 during the execution of the editing operation may include, for example, a trigger (for example, a click operation) for the control 230. As an example, the electronic device 110 may present a target interface in response to a trigger for the control 230.

As an example, the electronic device 110 may present a plurality of options in response to a trigger for the control 230. The plurality of options includes, for example, an option 1 (e.g., “continue to process”). Further, the electronic device 110 may present the target interface in response to a selection of the option1.

In some embodiments, as shown in FIG. 2F, the electronic device 110 may present the target interface 200F. As an example, the target interface 200F may be implemented as a viewing interface of an information stream.

Alternatively, the target interface may be implemented as an interface of other applications or a desktop or a lock screen interface associated with the electronic device 110. In this way, based on the embodiments of the disclosure, the user may switch the processing process to be in the background in the process of processing the media content or the template content, so as to perform other activities (for example, viewing the video content of the information stream, etc.) in the process of waiting for the processing to be completed, thereby improving the interaction efficiency of the user and meeting the user's requirements.

Additionally, the electronic device 110 may present reminding information associated with the editing operation in response to a completion of the editing operation.

In some embodiments, the media editing interface may be associated with a media application. As an example, the electronic device 110 may present, in response to the media application being in an activated state, a first reminding message associated with the editing operation. As an example, the media editing interface and the viewing interface of the information stream may be associated with the same media application. The electronic device 110 may present, in the media application (e.g., in the viewing interface of the information stream), a first reminding message associated with the editing operation in response to the media application being in an activated state (e.g., the viewing interface in which the information stream is being presented). As an example, the first reminding message may be associated with a first presentation style corresponding to the media application.

As an example, the electronic device 110 may present, in response to the media application being in an inactivated state, a second reminding message associated with the editing operation. As an example, the electronic device 110 may present a second reminding message associated with the editing operation in a desktop, a lock screen interface, or other applications. As an example, the second reminding message may correspond to a second presentation style. The second presentation style may be different from the first presentation style. The first presentation style or the second presentation style may indicate a text style (e.g., color, size, and / or font, etc.) and / or an image style (e.g., a bezel shape, size, and / or color, etc.) of the first reminding message or the second reminding message.

In some embodiments, the reminding message may include image content. The image content may indicate an editing result or an editing object of the editing operation.

In some embodiments, as shown in FIG. 2G, the electronic device 110 may present a reminding message 235 in the target interface 200G. As an example, the reminding message 235 may include image information and / or text information to indicate the content of a processing result. For example, a reminding message 235 may include text information (e.g., the editing has been processed) to indicate the editing operation to be completed. For example, the reminding message 235 may present image information associated with the editing operation to indicate the editing operation and / or the processing result corresponding to the reminding message 235.

In some embodiments, the electronic device 110 may present the media editing interface in response to a trigger (e.g., a click operation) for the reminding message (e.g., the reminding message 235). As an example, the media editing interface may correspond to an editing state after the editing operation is completed.

As an example, as shown in FIG. 2H, the electronic device 110 may present a media editing interface 200H in response to a trigger for the reminding message 235.

As an example, the electronic device 110 may present a publishing interface based on confirmation of the editing operation (e.g., a click operation for a control 236) in response to an editing state of the editing operation being in a state that the processing is completed. Further, the electronic device 110 may publish the to-be-edited content that is based on processing of the editing operation being completed in response to the publishing interface receiving a publishing request.

Alternatively, the electronic device 110 may re-execute the editing operation based on a received retry request (e.g., a trigger for a retry control (not shown)) in response to the editing state of the editing operation in which the processing is failed.

In some embodiments, as shown in FIG. 2I, the electronic device 110 may present a profile page 200I of the current user during the execution of the editing operation. The electronic device 110 may present a draft viewing entry 240 associated with the media editing interface in the profile page 200I. As an example, the draft viewing entry 240 indicates at least an execution state of the editing operation.

As an example, the draft viewing entry 240 may indicate the image information associated with the editing operation that is being executed.

Additionally or alternatively, the electronic device 110 may present, in the draft viewing entry 240, a type identifier associated with the content to be edited. For example, the type identifier may be implemented as an image identifier or a text identifier. As an example, the type identifier may indicate that the content to be edited is a media content type or a template content type.

Further, the electronic device 110 may present a draft viewing interface associated with the media editing interface in response to a selection of the draft viewing entry 240.

As an example, as shown in FIG. 2J, the electronic device 110 may present the draft viewing interface 200J. The electronic device 110, in the draft viewing interface 200J, may present a set of content items associated with a set of media drafts. As an example, a content item corresponding to a set of media drafts may include, for example, a content item 245-1, a content item 245-2, a content item 245-3, and the like. As an example, the set of media drafts may include a media content draft and / or a media template draft.

For example, the set of content items indicate a processing state of a historical editing operation corresponding to a set of media drafts.

As an example, the processing state may include a first processing state. The first processing state may indicate that a historical editing operation that is being processed. As an example, the content item 250-1 may correspond to the first processing state.

As an example, the processing state may include a second processing state. The second processing state may indicate that processing of the historical editing operation has been completed. As an example, the content item 250-2 may correspond to the second processing state.

As an example, the processing state may include a third processing state. The third processing state may indicate that processing of the historical editing operation fails. As an example, the content item 250-3 may correspond to the third processing state.

Additionally, the electronic device 110 may present, in response to a selection of a target content item of the set of content items, a media draft corresponding to the target content item in the media editing interface. The electronic device 110 may present description information indicating the processing state of the editing operation in the media editing interface.

Based on the process described above, the embodiments of the disclosure may cease presenting the editing interface without ceasing the editing operation based on the operation of the user during the execution of the editing operation. In addition, in the embodiments of the disclosure, after the editing operation is completed, the reminding message associated with the editing operation is presented, so that the editing interface may be jumped to by the user based on the reminding message, so as to view the editing state of the editing operation. As such, the embodiments of the disclosure can enable the user to leave the editing interface for carrying out other activities during the execution of the editing operation, saving the time of the user, satisfying the requirement of the user, and improving the efficiency of editing the content by the user.

### Example Process

FIG. 3 illustrates a flowchart of an example process 300 of editing content according to some embodiments of the disclosure. The process 300 may be implemented at the electronic device 110. The process 300 is described below with reference to FIG. 1.

As shown in FIG. 3, at block 310, the electronic device 110 executes, in response to an editing request received in a media editing interface, an editing operation associated with the editing request.

At block 320, the electronic device 110 ceases presenting the editing interface without terminating the editing operation in response to receiving a preset operation during execution of the editing operation.

At block 330, the electronic device 110 presents a reminding message associated with the editing operation in response to a completion of the editing operation.

At block 340, the electronic device 110 presents the media editing interface in response to a trigger for the reminding message, the media editing interface corresponding to an editing state after completion of the editing operation.

In some embodiments, the reminding message further includes an image content indicating an editing result or an editing object of the editing operation.

In some embodiments, ceasing presenting the editing interface without terminating the editing operation includes: ceasing presenting the editing interface without terminating the editing operation in response to a type of the editing operation satisfying a preset condition.

In some embodiments, the media editing interface is associated with a media application, and presenting the reminding message associated with the editing operation includes: presenting a first reminding message associated with the editing operation in response to the media application being in an activated state; or presenting a second reminding message associated with the editing operation in response to the media application being in an inactivated state, wherein the first reminding message and the second reminding message correspond to different message types.

In some embodiments, the process 300 further includes: presenting a profile page of a current user during execution of the editing operation; and presenting a draft viewing entry associated with the media editing interface in the profile page, the draft viewing entry indicating at least an execution state of the editing operation.

In some embodiments, the process 300 further includes: presenting a draft viewing interface associated with the media editing interface in response to a selection of the draft viewing entry; and presenting a set of content items associated with a set of media drafts in the draft viewing interface, the set of content items indicating a processing state of a historical editing operation corresponding to the set of media drafts.

In some embodiments, the process 300 further includes: presenting, in response to a selection of a target content item from the set of content items, a media draft corresponding to the target content item in the media editing interface.

In some embodiments, the processing state includes at least one of: a first processing state, indicating that the historical editing operation is being processed; a second processing state, indicating that the historical editing operation has been processed; and a third processing state, indicating that processing of the historical editing operation fails.

In some embodiments, before ceasing presenting the editing interface, the process 300 further includes: presenting an indication element in the media editing interface, the indication element representing a quantity and / or a processing progress of an editing operation being executed.

In some embodiments, the process 300 further includes: presenting the media editing interface associated with a media template in response to a selection of the media template.

### Example Apparatus and Device

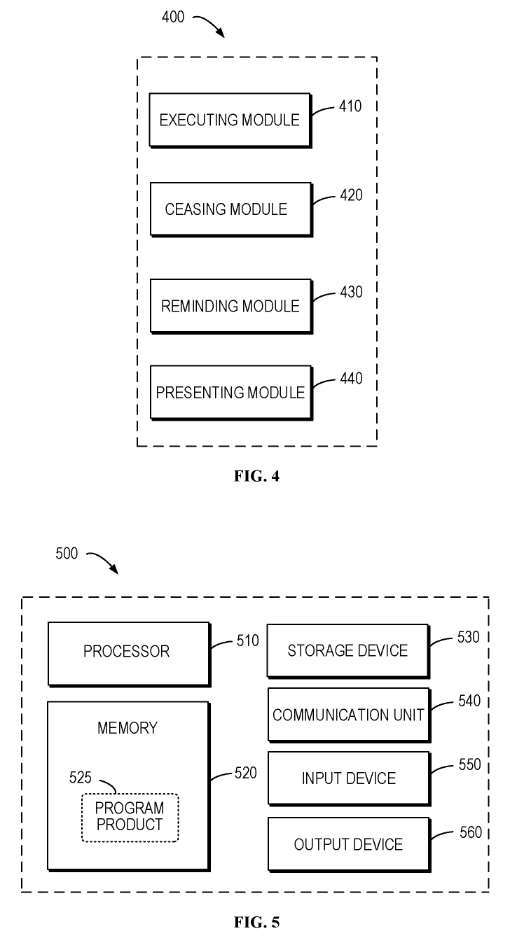

Embodiments of the disclosure also provide a corresponding apparatus for implementing the above method or process. FIG. 4 shows a schematic structural block diagram of an example apparatus 400 for editing content according to some embodiments of the disclosure. The apparatus 400 may be implemented or included in the electronic device 110. The various modules / components in the apparatus 400 may be implemented by hardware, software, firmware, or any combination thereof.

As shown in FIG. 4, the apparatus 400 includes: an executing module 410 configured to execute, in response to an editing request received in a media editing interface, an editing operation associated with the editing request; a ceasing module 420 configured to cease presenting the editing interface without terminating the editing operation in response to receiving a preset operation, during execution of the editing operation; a reminding module 430 configured to present a reminding message associated with the editing operation in response toa completion of the editing operation; and a presenting module 440 configured to present the media editing interface in response to a trigger for the reminding message, the media editing interface corresponding to an editing state after completion of the editing operation.

In some embodiments, the reminding message further includes an image content indicating an editing result or an editing object of the editing operation.

In some embodiments, the ceasing module 420 is further configured to cease presenting the editing interface without terminating the editing operation in response to a type of the editing operation satisfying a preset condition.

In some embodiments, the media editing interface is associated with a media application, and the presenting module 440 is further configured to: present a first reminding message associated with the editing operation in response to the media application being in an activated state; or present a second reminding message associated with the editing operation in response to the media application being in an inactivated state, wherein the first reminding message and the second reminding message correspond to different message types.

In some embodiments, the apparatus 400 further includes a profile page module configured to: present a profile page of a current user during execution of the editing operation; and present a draft viewing entry associated with the media editing interface in the profile page, the draft viewing entry indicating at least an execution state of the editing operation.

In some embodiments, the apparatus 400 further includes a draft entry module configured to present a draft viewing interface associated with the media editing interface in response to a selection of the draft viewing entry; and present a set of content items associated with a set of media drafts in the draft viewing interface, the set of content items indicating a processing state of a historical editing operation corresponding to the set of media drafts.

In some embodiments, the apparatus 400 further includes a draft viewing module configured to present, in response to a selection of a target content item from the set of content items, a media draft corresponding to the target content item in the media editing interface.

In some embodiments, the processing state includes at least one of: a first processing state, indicating that the historical editing operation is being processed; a second processing state, indicating that the historical editing operation has been processed; and a third processing state, indicating that processing of the historical editing operation fails.

In some embodiments, before ceasing presenting the editing interface, the apparatus 400 further includes an indication element module configured to: present an indication element in the media editing interface, the indication element representing a quantity and / or a processing progress of an editing operation being executed.

In some embodiments, the apparatus 400 further includes a selecting module configured to present the media editing interface associated with a media template in response to a selection of the media template.

The units included in the apparatus 400 may be implemented in various manners, including software, hardware, firmware, or any combination thereof. In some embodiments, one or more units may be implemented using software and / or firmware, such as machine-executable instructions stored on a storage medium. In addition to or as an alternative to machine-executable instructions, some or all of the units in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be used for the electronic device.

As shown in FIG. 5, the electronic device 500 is in a form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, a plurality of processing units executes computer-executable instructions in parallel to improve the parallel processing capability of the electronic device 500.

The electronic device 500 generally includes a plurality of computer storage media. Such media may be any available media that is accessible by the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and / or data and may be accessed within the electronic device 500.

The electronic device 500 may further include additional removable / non-removable, volatile / non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with other electronic device through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, a network profile computer (PC), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable the user to interact with the electronic device 500, or communicates with any device (e.g., a network card, a modem, etc.) that enables the electronic device 500 to communicate with one or more other electronic devices. Such communication may be executed via an input / output (I / O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and / or block diagrams of a method, an apparatus, a device, and a computer program product implemented in accordance with the disclosure. It should be understood that each block of the flowchart and / or block diagram, and combinations of blocks in the flowchart(s) and / or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions / acts specified in one or more blocks in the flowchart(s) and / or block diagram(s). These computer-readable program instructions may also be stored in a computer-readable storage medium that cause the computer, programmable data processing apparatus, and / or other devices to function in a particular manner, such that the computer-readable medium storing instructions includes an article of manufacture including instructions to implement aspects of the functions / acts specified in one or more blocks in the flowchart(s) and / or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions / acts specified in one or more blocks in the flowchart(s) and / or block diagram(s).

The flowchart and block diagrams in the figures show an architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and / or flowchart(s), as well as combinations of blocks in the block diagram(s) and / or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for editing content comprising:
executing, in response to an editing request received in a media editing interface, an editing operation associated with the editing request;
ceasing presenting the media editing interface without terminating the editing operation in response to receiving a preset operation during execution of the editing operation;
presenting a reminding message associated with the editing operation in response to a completion of the editing operation; and
presenting the media editing interface in response to a trigger for the reminding message, the media editing interface corresponding to an editing state after completion of the editing operation.

2. The method of claim 1, wherein the reminding message further comprises an image content indicating an editing result or an editing object of the editing operation.

3. The method of claim 1, wherein ceasing presenting the media editing interface without terminating the editing operation comprises:
ceasing presenting the media editing interface without terminating the editing operation in response to a type of the editing operation satisfying a preset condition.

4. The method of claim 1, wherein the media editing interface is associated with a media application and presenting the reminding message associated with the editing operation comprises:
presenting a first reminding message associated with the editing operation in response to the media application being in an activated state; or
presenting a second reminding message associated with the editing operation in response to the media application being in an inactivated state,
wherein the first reminding message and the second reminding message correspond to different message types.

5. The method of claim 1, further comprising:
presenting a profile page of a current user during execution of the editing operation; and
presenting a draft viewing entry associated with the media editing interface in the profile page, the draft viewing entry indicating at least an execution state of the editing operation.

6. The method of claim 5, further comprising:
presenting a draft viewing interface associated with the media editing interface in response to a selection of the draft viewing entry; and
presenting a set of content items associated with a set of media drafts in the draft viewing interface, the set of content items indicating a processing state of a historical editing operation corresponding to the set of media drafts.

7. The method of claim 5, further comprising:
presenting, in response to a selection of a target content item from the set of content items, a media draft corresponding to the target content item in the media editing interface.

8. The method of claim 6, wherein the processing state comprises at least one of:
a first processing state, indicating that the historical editing operation is being processed;
a second processing state, indicating that the historical editing operation has been processed;
the third processing state indicates that processing of the historical editing operation fails.

9. The method of claim 1, wherein before ceasing presenting the media editing interface, the method further comprises:
presenting an indication element in the media editing interface, the indication element representing a quantity and/or a processing progress of an editing operation being executed.

10. The method of claim 1, further comprising:
presenting the media editing interface associated with a media template in response to a selection of the media template.

11. An electronic device, comprising:
at least one processor; and
at least one memory coupled to the at least one processor and storing instructions for execution by the at least one processor, the instructions, when executed by the at least one processor, causing the electronic device to performacts comprising:
executing, in response to an editing request received in a media editing interface, an editing operation associated with the editing request;
ceasing presenting the media editing interface without terminating the editing operation in response to receiving a preset operation during execution of the editing operation;
presenting a reminding message associated with the editing operation in response to a completion of the editing operation; and
presenting the media editing interface in response to a trigger for the reminding message, the media editing interface corresponding to an editing state after completion of the editing operation.

12. The electronic device of claim 11, wherein the reminding message further comprises an image content indicating an editing result or an editing object of the editing operation.

13. The electronic device of claim 11, wherein ceasing presenting the media editing interface without terminating the editing operation comprises:
ceasing presenting the media editing interface without terminating the editing operation in response to a type of the editing operation satisfying a preset condition.

14. The electronic device of claim 11, wherein the media editing interface is associated with a media application and presenting the reminding message associated with the editing operation comprises:
presenting a first reminding message associated with the editing operation in response to the media application being in an activated state; or
presenting a second reminding message associated with the editing operation in response to the media application being in an inactivated state,
wherein the first reminding message and the second reminding message correspond to different message types.

15. The electronic device of claim 11, wherein the acts further comprise:
presenting a profile page of a current user during execution of the editing operation; and
presenting a draft viewing entry associated with the media editing interface in the profile page, the draft viewing entry indicating at least an execution state of the editing operation.

16. The electronic device of claim 15, wherein the acts further comprise:
presenting a draft viewing interface associated with the media editing interface in response to a selection of the draft viewing entry; and
presenting a set of content items associated with a set of media drafts in the draft viewing interface, the set of content items indicating a processing state of a historical editing operation corresponding to the set of media drafts.

17. The electronic device of claim 15, wherein the acts further comprise:
presenting, in response to a selection of a target content item from the set of content items, a media draft corresponding to the target content item in the media editing interface.

18. The electronic device of claim 11, wherein before ceasing presenting the media editing interface, and the acts further comprise:
presenting an indication element in the media editing interface, the indication element representing a quantity and/or a processing progress of an editing operation being executed.

19. The electronic device of claim 11, wherein the acts further comprise:
presenting the media editing interface associated with a media template in response to a selection of the media template.

20. A non-transitory computer-readable storage medium having stored thereon a computer program executable by a processor to perform acts comprising:
executing, in response to an editing request received in a media editing interface, an editing operation associated with the editing request;
ceasing presenting the media editing interface without terminating the editing operation in response to receiving a preset operation during execution of the editing operation;
presenting a reminding message associated with the editing operation in response to a completion of the editing operation; and
presenting the media editing interface in response to a trigger for the reminding message, the media editing interface corresponding to an editing state after completion of the editing operation.
